(19) United States
(12) Patent Application Publication
(10) Pub. No.: US 2010/0241582 A1
(43) Pub. Date: Sep. 23, 2010

(54) Career planning and job search management

(76) Inventor: David Culverwell, Serverna Park, MD (US)

Correspondence Address: Kenneth F. Kozik, 43 Mohawk Drive, Acton, MA, 01720-2343, US

(21) Appl. No.: 12/661,368

(22) Filed: Mar. 16, 2010

Related U.S. Application Data
(60) Provisional application No. 61/161,259, filed on Mar. 18, 2009.

(51) Int. Cl. G06Q 10/00; G06F 17/30

(52) U.S. Cl. 705/321; 707/706; 707/E17.108

(57) ABSTRACT

Methods and apparatus, including computer program products, for career planning and job search management. A method includes, in a network of interconnected computers, displaying a menu of web productivity tools on a graphical user interface (GUI) on an input/output (I/O) device of a computing system, the web productivity tools including a contacts manager tool, a scheduler tool, a resume builder tool, a personal statement builder tool, an interview preparation tool and a self-assessment tool, receiving an indication through the GUI of which of the web productivity tools to execute, executing the indicated web productivity tool, and integrating data received and stored for each of the web productivity tools.

### CROSS-REFERENCE TO RELATED APPLICATIONS

This application claims the benefit of U.S. Provisional Application No. 61/161,259, filed Mar. 18, 2009, and titled CAREER PLANNING AND JOB SEARCH MANAGEMENT SYSTEM, which is incorporated by reference in its entirety.

### BACKGROUND OF THE INVENTION

The invention generally relates to secure electronic systems, and more specifically to career planning and job search management.

People searching for a job in trying economic times can turn to a variety of disparate resources. For example, school career counseling centers may offer resume writing services, job search tools, interview preparation, and so forth. Such resources are also available online and in hard copy format in, for example, public libraries. Because each aspect of any job search uses different resources, a job seeker is forced to spend an inordinate amount of time consolidating and cross referencing relevant information from many sources to form a single resource. Given the fast pace at which job announcements are posted online, as well as the current high rate of unemployment, job seekers need a streamlined process to identify and find employment. It is desirable, therefore, to make available the various resources a job seeker needs electronically in a seamless manner that is compatible with popular software applications so the job seeker can obtain the information he or she needs to pursue a job lead, schedule interviews and get assistance and information about the job search process in a one-stop electronic shop.

### SUMMARY OF THE INVENTION

The present invention provides methods and apparatus, including computer program products, for career planning and job search management.

A method and system provides a suite of web productivity tools that help a user organize and manage a job search using networking to increase the chances of obtaining a meaningful and fulfilling job. This suite of web productivity tools enables an inexpensive, quick and organized approach to planning and managing a job search, and can include a job search engine, a process to research occupations and industries, a process to aid in writing an effective resume, a process to prepare users for a job interview, and a process to enable job search through effective networking.

In general, in one aspect, the invention features a career planning and job search management method including, in a network of interconnected computers, displaying a menu of web productivity tools on a graphical user interface (GUI) on an input/output (I/O) device of a computing system, the web productivity tools including a contacts manager tool, a scheduler tool, a resume builder tool, a personal statement builder tool, an interview preparation tool and a self-assessment tool, receiving an indication through the GUI of which of the web productivity tools to execute, executing the indicated web productivity tool, and integrating data received and stored for each of the web productivity tools.

In another aspect, the invention features a system including, in a network of interconnected computers, a client and a server linked to the network, the client including a processor and memory, memory including a browser for display of a graphical user interface (GUI), and the server including a processor and memory, memory including a career planning and job search management process. The career planning and job search management process includes displaying a menu of web productivity tools on the GUI, the web productivity tools including a contacts manager tool, a scheduler tool, a resume builder tool, a personal statement builder tool, an interview preparation tool and a self-assessment tool, receiving an indication through the GUI of which of the web productivity tools to execute, executing the indicated web productivity tool, and integrating data received and stored for each of the web productivity tools.

Other features and advantages of the invention are apparent from the following description, and from the claims.

### BRIEF DESCRIPTION OF THE DRAWINGS

The invention will be more fully understood by reference to the detailed description, in conjunction with the following figures, wherein:

FIG. 1 is a block diagram.

FIG. 2 is a flow diagram.

FIG. 3 is a graphical user interface (GUI).

FIG. 4 is a block diagram of a wizard.

FIG. 5 is GUI

FIG. 6 is GUI.

FIG. 7 is block diagram of a tool.

Like reference numbers and designations in the various drawings indicate like elements.

### DETAILED DESCRIPTION

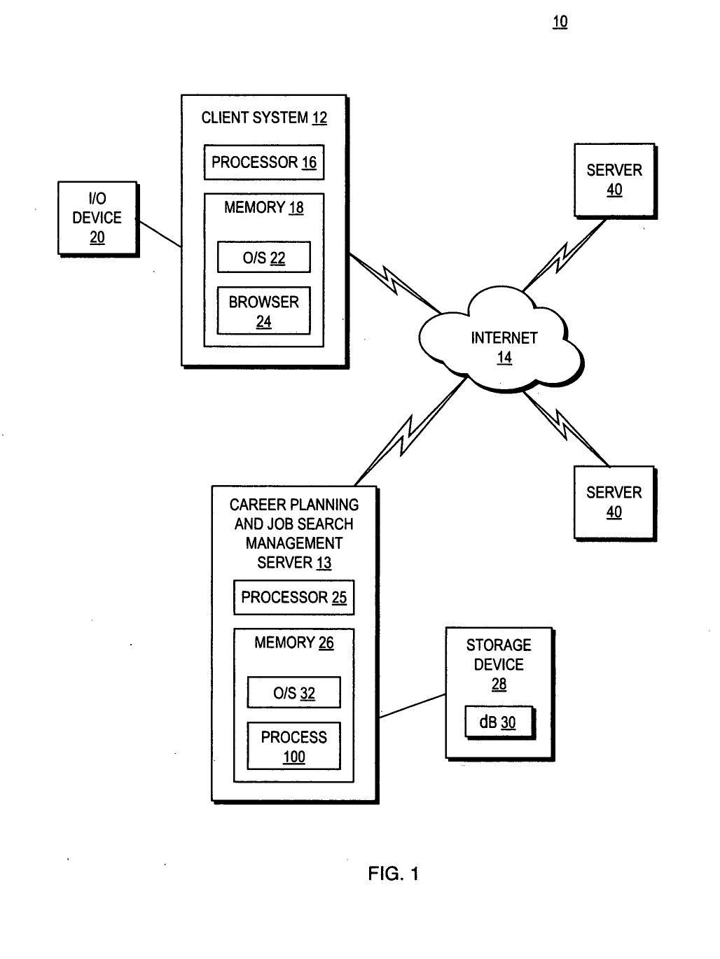

As shown in FIG. 1, a network 10 includes at least a client system 12 and a career planning and job search management server system 13 linked to a network 14 of interconnected computers, e.g., the Internet. The client system 12 includes at least a processor 16, memory 18 and input/output (I/O) device 20. Memory 18 includes an operating system 22, such as Linux, Apple Snow Leopard®, or Microsoft Windows®, and a browser 24, such as Mozilla Firefox®, Opera®, Safari® or Microsoft Internet Explorer®. In general, a browser is a software application that retrieves content and enables a user to interact with that content. In an example, a browser may retrieve content across one or more networks, such as the Internet 14. The content may include, for example, a web page, application, document, text, video, multimedia content, and so forth.

In one example, the career planning and job search management server system 13 includes at least a processor 25, a memory 26 and a storage device 28 for storing one or more databases 30. In other examples, the one or more databases 30 are stored remotely on one or more storage servers (not shown) linked to the network 14.

Memory 26 includes an operating system 32, such as Linux or Microsoft Windows®, and a career planning and job search management process 100, fully described below. The career planning and job search management process 100 provides a suite of web productivity tools that help a user organize and manage a job search using networking to increase the chances of obtaining a meaningful and fulfilling job. This suite of web productivity tools enables an inexpensive, quick and organized approach to planning and managing a job search.

Network 10 also includes one or more servers 40. These servers 40 may contain job listings, geographic locations, and so forth, and this information can be streamed to process 100 or searched or delivered upon request by process 100.

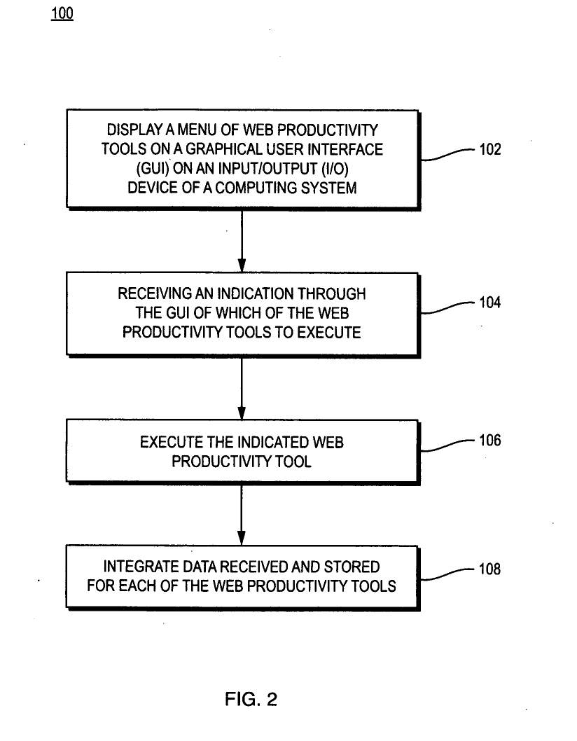

As shown in FIG. 2, the career planning and job search management process 100 includes displaying (102) a main menu of web productivity tools on a graphical user interface (GUI), the web productivity tools including a contact manager tool, a scheduler tool, a resume builder tool, personal statement builder tool, an interview preparation tool and a self-assessment tool.

The contact manager tool enables a user to organize all of their professional networking contact information in a single place. The contact manager tool can download contacts from Microsoft Outlook®, Google® Gmail, Yahoo!® e-mail, LinkedIn®, Plaxo® and most other personal information managers (PIMs). Each entry in the contacts manager includes suggestions on what to say and what to ask as a user moves their job search forward.

The scheduler tool enables a user to keep track of their job search action plans. The scheduler tool executes continuously to drive a weekly to do list based on the user's input. The to-do list can be downloaded to Outlook® and a personal data assistant (PDA).

The resume builder tool enables interactive building of an effective resume.

The personal statement builder tools enables interactive building of what is sometimes referred to as a “30 second elevator pitch,” which can be used when potential employers and/or networking contacts want a brief statement from the user.

the interview preparation tool enables a user to practice interviewing skills within an interactive interview setting.

The self-assessment tool enables a user to take a personal assessment to measure the user's interests and skills, and learn which occupations might be right for the user.

The career planning and job search management process 100 receives (104) an indication through the GUI of which of the web productivity tools to execute. The indication can include receiving a mouse click, a numeric input, a space bar click, or other suitable indication.

The career planning and job search management process 100 executes (106) the selected web productivity tool.

The career planning and job search management process 100 integrates (108) data received and stored for each of the web productivity tools.

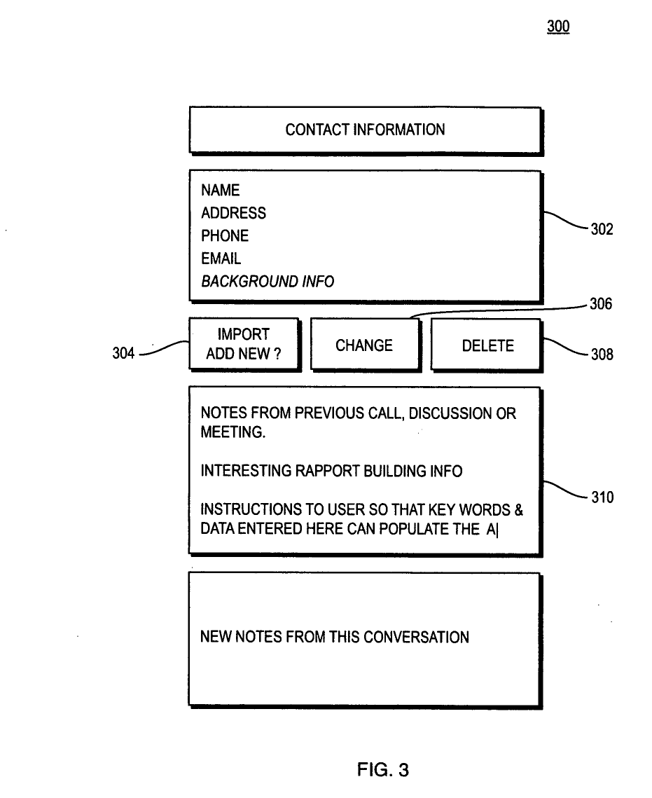

As shown in FIG. 3, the contacts manager tool displays a contacts information GUI 300. The contact information GUI 300 includes a general information section 302 that enables a user to enter contact information such as name, address, phone number, email and background information.

The GUI 300 includes options to import or add new contacts 304, change contact information 306 and delete contact information 308. The GM 300 includes an option to enter supplemental information, such as notes from previous calls, rapport building information. The GUI 300 also includes instructions 310 to the user so that key words and data entered here can populate the other web productivity tools.

Contact information can be arranged by contact level, groups and organizations, and may be color-coded to distinguish people who the user knows, opportunities, referred contacts and interviews.

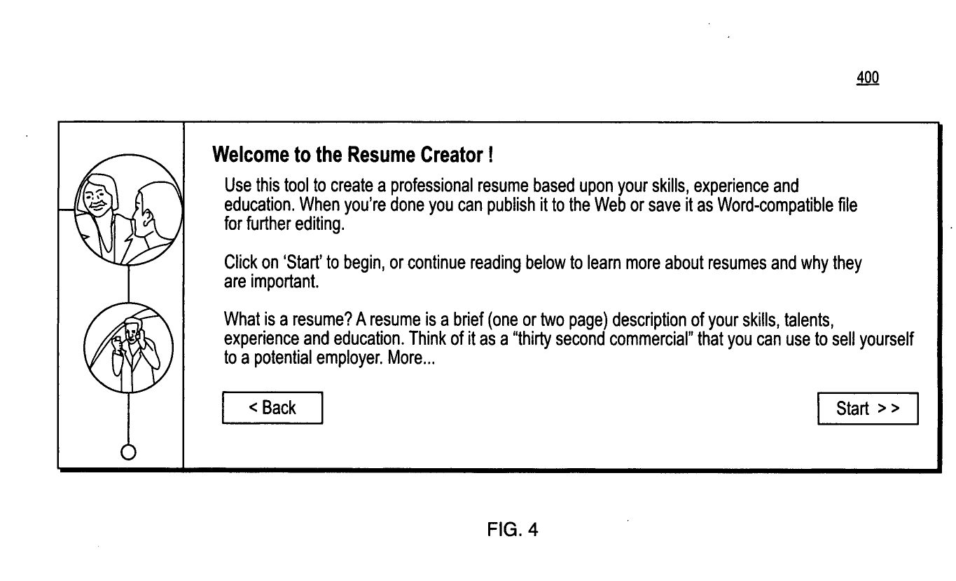

As shown in FIG. 4, the resume builder tool displays a resume creator wizard 400. The wizard 400 enables the user to systematically build an effective resume through a series of prompts, which, when assembled, create a user resume. The prompts include, for example, objective, qualifications, experience and education. The prompts may also include accomplishments and personal statement, which is sometime referred to as “an elevator pitch.”

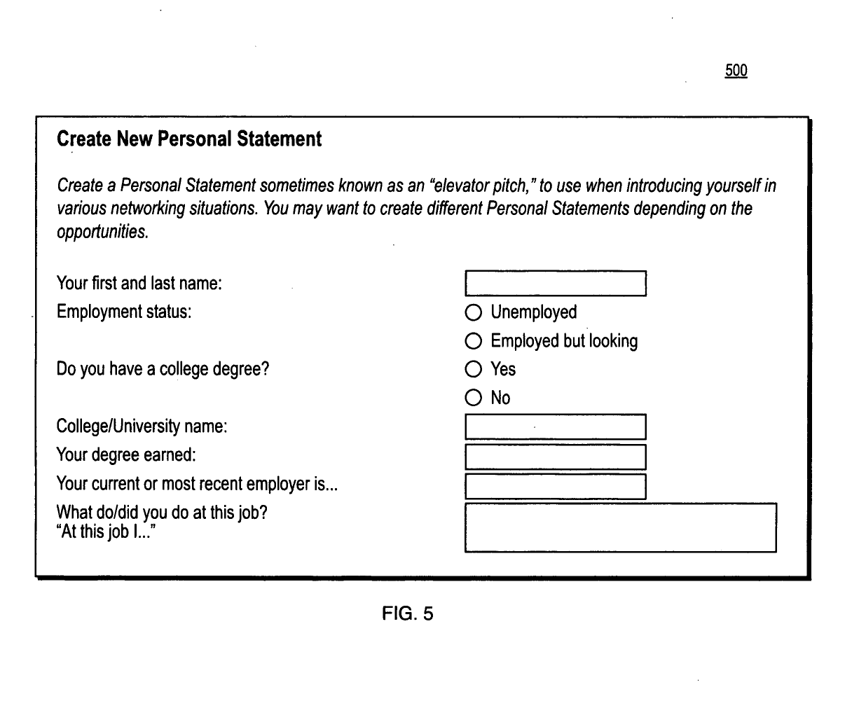

As shown in FIG. 5, the personal statement builder tool displays a personal statement GUI 500 that prompts the user to generate an effective personal statement, sometimes referred to as “an elevator pitch.”

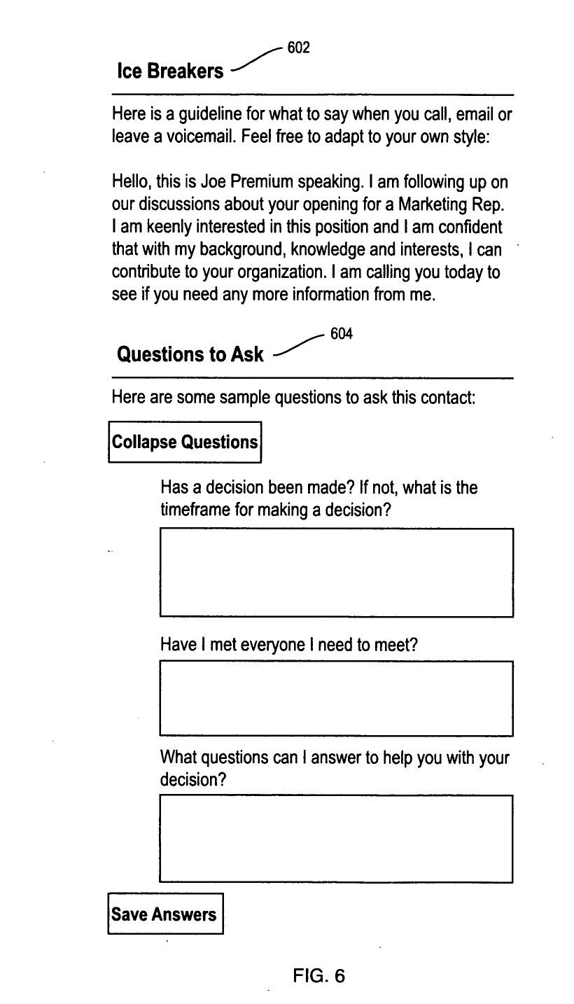

As shown in FIG. 6, the interview preparation tool displays a GUI 600 that enables a user to define ice breakers 602 and questions to ask 604.

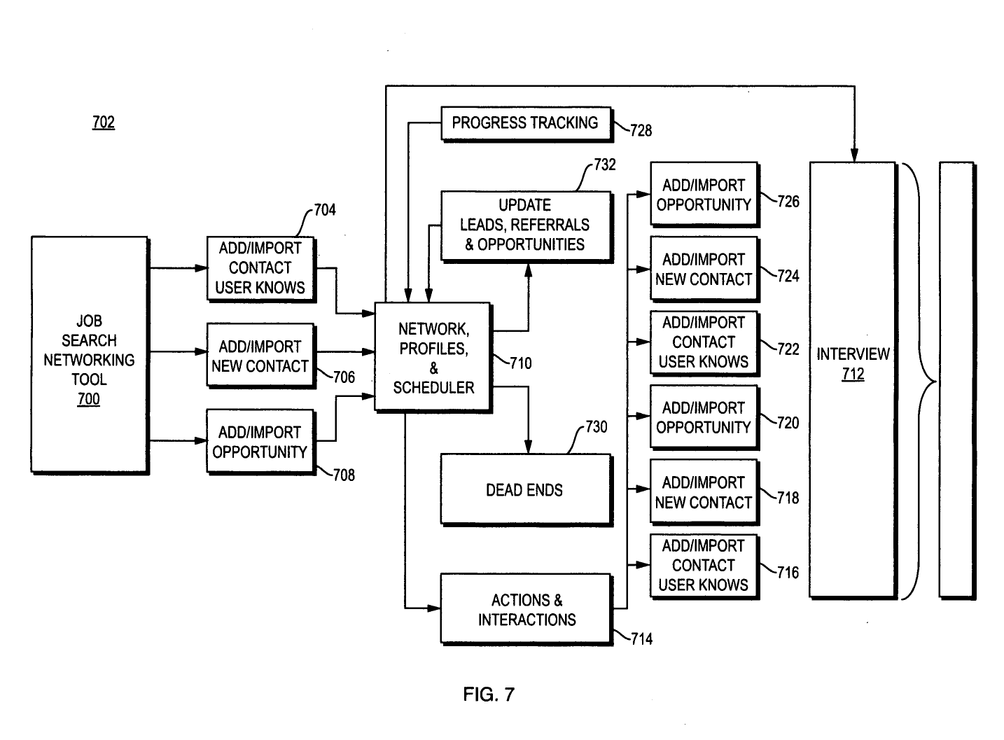

As shown in FIG. 7, the self-assessment tool 700 provides an architecture 702 for an effective job search. The architecture 702 includes adding and/or importing contacts that the user knows 704, adding/importing new contacts 706 and adding/importing opportunities 708. This contact/opportunity information 704, 706, 708 is passed to a scheduler 710.

The scheduler 710 may lead to an interview 712 and/or actions and interactions 714. Actions and interaction 714 lead add to further information input 716, 718, 720, 722, 724, 726, and to progress tracking 728.

The scheduler 710 can lead to dead ends 730 or an updating of leads, referrals and opportunities 732.

The search tool 700 provides a framework for organizing job search information, building a professional network and systematically pursuing job opportunities. This framework adjusts the suggestions, advice and feedback it gives users depending on where the user is in the job search process, how well the job seeker knows the individual he or she is contacting, and the job seekers progress toward an employment opportunity.

The career planning and job search management process 100 enables job seekers to consolidate in a database all their useful contacts from all of the other networking sites used and select only those they feel will be helpful in a job search. The career planning and job search management process 100 satisfies the need for a single source job search, organizer, scheduler, career planner and professional networking tool. By providing an interactive method for structuring and organizing the various tasks and data involved in a job search, career planning and job search management process 100 meets unmet needs in the job seeking population.

Career planning and job search management process 100 enables a download and upload of timing of network contacts automatically between the job search and the job seekers calendar, based on preset timing parameters. Career planning and job search management process 100 provides automated guidance to job seekers about which contacts to add to their database, including context specific scripts designed to prompt the job seeker into maximizing the effectiveness of each attempted contact.

The career planning and job search management process 100 enables a skills assessment through relationships with third-party vendors such that the job seeker is able to determine, in addition to work experience, what other job opportunities may be compatible with other user-defined criteria such as interests, type of work environment, and so forth.

The career planning and job search management process 100 provides a multi-pronged job opportunity search system that is easily portable, it can be backed up electronically, by simultaneously providing access to job listings and making contact with the relevant contact persons beginning with contacts the job seeker already knows, then moving outwards to more distant contacts.

The career planning and job search management process 100 eases the psychological effects of reaching out to indirect contacts for job leads by providing customized, individual and industry specific advice on making contact with such job leads.

The career planning and job search management process 100 enables a user to create a customized, industry-specific resume and cover letter without the need for human intervention based on a few key points the job seeker wants to resume reviewer to remember about him or her, then automatically calendars follow-up dates based on user input.

The career planning and job search management process 100 automates the task of remembering the most desirable method of contacting the jobs and generating compatible documents accordingly. For example, if the stored data indicates that the job prefers e-mail, career planning and job search management process 100 automatically converts a cover letter to a non-editable format acceptable to the recipient, signs a letter with a valid electronic signature, and e-mails the resume and cover letter to the recipient. On the other hand, if the stored data indicates that the job prefers first first-class mail, career planning and job search management process 100 generates a hard copy of the resume and cover letter for the job seeker's signature and mailing.

The career planning and job search management process 100 provides customized, industry specific information about preparing for various types of job interviews, including initial phone screenings all the way through daylong meetings with multiple executives.

The career planning and job search management process 100 may also provide, through one or more strategic partnerships with third party providers, online exercises for learning and practicing interviewing skills, including but not limited to, mock interviews via videoconferencing.

The career planning and job search management process 100 keeps job seekers motivated by providing a mechanism for sending periodic job-search goals in terms of numbers of contacts to be made, resumes to be sent, new leads to be generated, and networking events to be attended, tracking the events, and providing periodic reports on progress made.

The career planning and job search management process 100 provides automated suggestions and encouragement if job seekers do not achieve their job search goals. The career planning and job search management process 100 has an automated analytic capability for sending encouraging messages and guidance depending on specific user activity or lack of activity.

The career planning and job search management process 100 automates and organizes the process of conducting a structured job search by directly connecting job seekers and potential employers. More specifically, the career planning and job search management process 100 identifies attributes that match job seeker and employer preferences and uses professional networking to facilitate connections. Job search networking provides a framework for organizing job search information, building a professional network, and systematically' pursuing job opportunities. A relationship management component helps job seekers build their network by recommending people they know, expanding through leads and referrals. A color-coded and ranking contact relationship management tool enables the job seeker to make and track connections with people who can assist them during their job search and throughout their career. The career planning and job search management process 100 enables users to import contacts from popular contact management systems.

Color coding is used to show the relative importance of contacts and organizations with respect to employment opportunities and to highlight and track your priorities in progress. As the user builds a professional network, an automated scheduling component with reminder features notifies the user when to take initial steps and follow-up actions. The scheduler includes automatically updated “to do” information and reminders. Instructional components guide users through the job search process using scripts, suggested questions, and recommendation for initiating connections with contacts, interviewing them, and creating follow-up actions.

In some of the graphical user interfaces described above, drop-down screens enable extensive storage and organization of information about the job seekers contacts, connections, and organizations gathered during the job search process. Career planning and job search management process 100 enables users to easily collect, store and recall information for use during iteration or for later reference. These drop-down screens can be triggered by voice commands, touchscreen, computer interaction using a mouse, or other appropriate electronic interaction.

The career planning and job search management process 100 includes a methodology for the job seeker to categorize contacts, annotate his or her potential to provide opportunities for future employment and to track the progress, including scheduling initial calls and follow-up calls, future meetings, and so forth. A goal is to give job seekers a networking tool to help job seekers effectively find hidden jobs that have not been openly advertised or recruited for, but which are usually filled by referrals or recommendations from people who know both the employer and prospective employee or would have some other: mutual contacts.

In one embodiment, data from companies in which the job seeker is interested in seeking employment is automatically downloaded to the job seekers database for future reference. However, the job seeker can also enter and edit such data himself. Any handheld or ancillary devices, such as external hard drives, that hold the job seekers job-search database is synchronized with the updated data in real-time or near real time so that any device that holds the job seekers information always has the most accurate, up to date information available.

The career planning and job search management process 100 automatically downloads information about when to make job-search connections and when to follow-up with the connections into the job seekers electronic calendar.

The career planning and job search management process 100 permits a strategic alliance between the user and third parties to provide a skills assessment component that enables subscribers to determine, in addition to work experience, what other job opportunities may be complementary to the job seeker's interests. This also provides information that can help the job seeker tailor their resume to a variety of opportunities.

Once the job seeker identifies job opportunities to be pursued, a comprehensive, multipronged job opportunities search can begin. This involves at least simultaneously reviewing job listings and opportunities on job boards and connecting with contacts who may be able to assist in the job search by providing additional contacts collected late may connect the job seeker with prospective employers. The job seeker begins by contacting those to whom he or she is closest and then moving towards contacting those referrals or separated by 1°, then 2°, and so forth.

When a job seeker begins to initiate contact with a person who is not a direct contact, career planning and job search management process 100 automatically indexes the degree of separation and provides the job seeker with context specific information on strategies for contacting someone who is not directly known to them within the industry in which the contact works. Process 110 recommends, based on the available information, the best method of contacting the prospective job lead contact person, and displays the information to the job seeker. Career planning and job search management process 100 functions like a virtual career counselor, always available when the job seeker needs advice and avoids the need for a personal meeting. This functionality alleviates some of the anxiety a job seeker feels when contacting a prospective job lead with no prior introduction to the job lead. Career planning and job search management process 100 then organizes the leads generated from these contacts according to the degree to which such leads represent a meaningful opportunity to the job seeker based on user-defined criteria.

In one example, career planning and job search management process 100 consultants public transportation schedules to ensure the job seeker can realistically attend a job interview at the proposed time given the constraints of public transportation schedules as well as a travel budget if desired to ensure the job seeker can afford to attend the interview if transportation is not being paid for by the prospective employer. Career planning and job search management process 100 then checks to ensure there are no conflicts for the proposed interview including travel time and inserts the appointment on the job seeker's calendar.

When an interview has been scheduled, career planning and job search management process 100 provides information pertaining to job interview, customized with the industry if desired.

To keep job seekers motivated in the job search, career planning and job search management process 100 requires job seekers to attempt to reach periodic goals related to job search, such as, but not limited to, number of contacts to make, resumes to send, new contacts/leads generated, and networking events to be attended. Career planning and job search management process 100 may generate periodic progress reports that include performance criteria. If the career planning and job search management process 100 detects that the job seeker is not meeting set goals, it provides suggestions and encouragement to motivate job seekers into working harder to reach the goals.

After the job seeker receives a job offer, career planning and job search management process 100 gives the applicant guidance about reviewing, evaluating, and accepting the offer and provides data on salaries, benefits and other relevant information for similar positions in the relevant geographic location, avoiding the need to wait for a career counselor to provide feedback and also avoiding the need to use recruiters who get paid by commission.

In one specific example, career planning and job search management process 100 provides advice as a job tip of the day, a weekly syndicated job-search column, a networking and career blog that is updated several times a week, and job, career, and lifestyle issues that are updated daily.

In another example, career planning and job search management process 100 utilizes a web crawler or similar device to monitor electronic information sources or information about companies for which the job seeker wishes to work. When new information about such companies becomes available, career planning and job search management process 100 alerts the job seeker and provides the job seeker with a copy of the information.

In one specific example, a calendaring tool automatically enables slightly more time to pass in following up with lower priority job leads so the tasks are spread out more evenly and the user isn't overwhelmed with many task due dates and nothing to do in the future.

In another specific example, career planning and job search management process 100 includes an administrative component that enables an administrator to monitor the activity and progress of the job seeker and make specific recommendations, advice and encouragement to help keep the job seeker on track and making forward progress in their job search.

Embodiments of the invention can be implemented in digital electronic circuitry, or in computer hardware, firmware, software, or in combinations of them. Embodiments of the invention can be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand alone program or as a module, component, subroutine, or other unit suitable for use in a computing environment. A computer program can be deployed to be executed on one computer or on multiple computers at one site or distributed across multiple sites and interconnected by a communication network.

Method steps of embodiments of the invention can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Information carriers suitable for embodying computer program instructions and data include all forms of non volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in special purpose logic circuitry.

It is to be understood that the foregoing description is intended to illustrate and not to limit the scope of the invention, which is defined by the scope of the appended claims. Other embodiments are within the scope of the following claims.

What is claimed is:

1. A career planning and job search management method comprising:
in a network of interconnected computers, displaying a menu of web productivity tools on a graphical user interface (GUI) on an input/output (I/O) device of a computing system, the web productivity tools including a contacts manager tool, a scheduler tool, a resume builder tool, a personal statement builder tool, an interview preparation tool and a self-assessment tool;
receiving an indication through the GUI of which the web productivity tools to execute;
executing the indicated web productivity tool; and
integrating data received and stored for each of the web productivity tools.

2. The method of claim 1 wherein the contacts manager tool enables a user to organize all of their professional networking contact information in a single place.

3. The method of claim 2 wherein each entry in the contacts manager includes suggestions on what to say and what to ask as a user moves a job search forward.

4. The method of claim 1 wherein the scheduler tool enables a user to keep track of job search action plans.

5. The method of claim 4 where the scheduler tool executes continuously to drive a weekly to-do list based on the user's input.

6. The method of claim 5 wherein the to-do list can be downloaded to external calendering systems and personal data assistants (PDAs).

7. The method of claim 1 wherein the resume builder tool enables a user to interactively build an effective resume.

8. The method of claim 1 wherein the personal statement builder tool enables interactive building of a 30 second elevator pitch, which can be used when potential employers and/or networking contacts want a brief statement from a user.

9. The method of claim 1 wherein the interview preparation tool enables a user to practice interviewing skills within an interactive interview setting.

10. The method of claim 1 wherein the self-assessment tool enables a user to take a personal assessment to measure the user's interests and skills, and learn which occupations might be right for the user.

11. The method of claim 1 wherein self-assessment tool enables a user to perform a job search using the integrated data.

12. The method of claim 11 wherein the job search comprises:
searching job listing web sites residing on servers linked to the network;
determining job matches;
displaying the job matches on the GUI to a user; and
displaying one or more strategies to engage employers of the job matches.

13. The method of claim 12 wherein the one or more strategies comprises contacting the employers through an employee.

14. The method of claim 1 where the indication can include receiving a mouse click, a numeric input, a space bar click, or other suitable indication.

15. A system comprising:
in a network of interconnected computers, a client and a server linked to the network;
the client comprising a processor and memory, memory including a browser for display of a graphical user interface (GUI);
the server comprising a processor and memory, memory including a career planning and job search management process, the career planning and job search management process comprising:
displaying a menu of web productivity tools on the GUI, the web productivity tools including a contacts manager tool, a scheduler tool, a resume builder tool, a personal statement builder tool, an interview preparation tool and a self-assessment tool;
receiving an indication through the GUI of which the web productivity tools to execute;
executing the indicated web productivity tool; and
integrating data received and stored for each of the web productivity tools.

16. The system of claim 15 wherein self-assessment tool enables a user to perform a job search using the integrated data.

17. The system of claim 16 wherein the job search comprises:
searching job listing web sites residing on servers linked to the network;
determining job matches;
displaying the job matches on the GUI to a user; and
displaying one or more strategies to engage employers of the job matches.

18. The system of claim 17 wherein the one or more strategies comprises contacting the employers through an employee.
